(19) United States
(12) Patent Application Publication
(10) Pub. No.: US 2004/0214473 A1
(43) Pub. Date: Oct. 28, 2004

(54) Fuse hole plug and fuse box device

(75) Inventor: Akemi Maebashi, Shizuoka (JP)

Correspondence Address: Finnegan, Henderson, Farabow,, Garrett & Dunner, L.L.P., 1300 I Street, N.W., Washington, DC, 20005-3315, US

(73) Assignee: YAZAKI CORPORATION

(21) Appl. No.: 10/828,203

(22) Filed: Apr. 21, 2004

(30) Foreign Application Priority Data
Apr. 22, 2003 (JP) 2003-117227

(51) Int. Cl. H01R 13/68

(52) U.S. Cl. 439/621

(57) ABSTRACT

A fuse hole plug is configured to be inserted in a fuse hole which is not designated to receive a fuse with a fuse puller. The fuse hole plug has a head member having a width wider than a width of the fuse hole.

### CROSS REFERENCE TO RELATED APPLICATIONS

This application is based upon and claims the benefit of priority from the prior Japanese Patent Applications No. P2003-117227, filed on Apr. 22, 2003; the entire contents of which are incorporated herein by reference.

### BACKGROUND OF THE INVENTION

1. Field of the Invention

The present invention relates to a fuse hole plug inserted into a fuse hole and a fuse box device having a plurality of fuse holes configured to received one of a fuse and the fuse plug.

2. Description of the Related Art

Prior art relating to a fuse hole plug is disclosed in Japanese Laid Open (Kokai) No.2001-84890. As shown in FIG. 1, a plurality of insertion sections 51 is established in a line. Each of the insertion sections 51 has a fuse hole 52. A pair of fuse terminals (not shown in FIG. 1) is located inside the fuse hole 52. A fuse hole plug 55 has a shape similar to a fuse. The fuse hole plug 55 comprises a grip portion 55a and a pair of dummy terminals 55b extending from the bottom of the grip portion 55a. The grip portion 55a and the dummy terminals 55b are made of resin.

The fuse hole plug 55 fills the insertion hole 52 which is not designated to receive a fuse. Consequently, insertion of a fuse into a fuse hole 52 can be prevented.

However, the fuse hole plug 55 has a shape so similar to the fuse that the fuse hole plug 55 can be accidentally pulled out from the fuse hole 52. Foreign matter, water, conductive dirt and the like inside the fuse hole 52 where the fuse hole plug 55 is removed may cause mechanical errors. Also, each of the dummy terminals 55b damages a slit of a fuse terminal by insertion into the slit and expansion of the width of the slit.

### SUMMARY OF THE INVENTION

An aspect of the present invention inheres in a fuse hole plug configured to be inserted in a fuse hole which is not designated to receive a fuse with a fuse puller, the fuse hole plug including a head member having a width wider than a width of the fuse hole.

An another aspect of the present invention inheres in a fuse box device including a fuse box having a plurality of fuse holes configured to receive one of a fuse a fuse hole plug having a head member to be inserted in at least one of the plurality of fuse holes when a fuse is unnecessary and a fuse puller configured to remove a fuse from at least one of the plurality of fuse holes, wherein the head member has a width wider than a width between arms of the fuse puller.

### BRIEF DESCRIPTION OF DRAWINGS

FIG. 1 is a oblique perspective figure schematically showing the fuse hole and the insertion section of the prior art.

FIG. 2 is an oblique perspective figure schematically showing the fuse box took apart of the present invention.

FIG. 3 is a cross section figure schematically showing the fuse box of the present invention.

FIG. 4 is a top view of the insertion section schematically showing the fuse hole plug of the present invention.

FIG. 5 is an oblique perspective figure schematically showing the fuse hole plug of the present invention.

FIG. 6 is a cross section figure along the line VI-VI in FIG. 4 schematically showing the fuse hole plug of the present invention.

FIG. 7 is a cross section figure along the line VII-VII in FIG. 4 schematically showing the fuse-hole plug of the present invention.

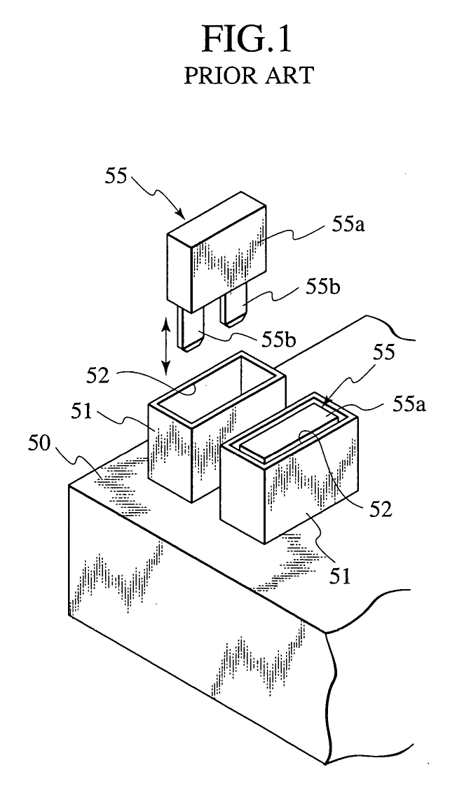

### DETAILED DESCRIPTION OF EMBODIMENTS

Various embodiments of the present invention will be described with reference to the accompanying drawings. It is to be noted that the same or similar reference numerals are applied to the same or similar parts and elements throughout the drawings, and the description of the same or similar parts and elements will be omitted or simplified.

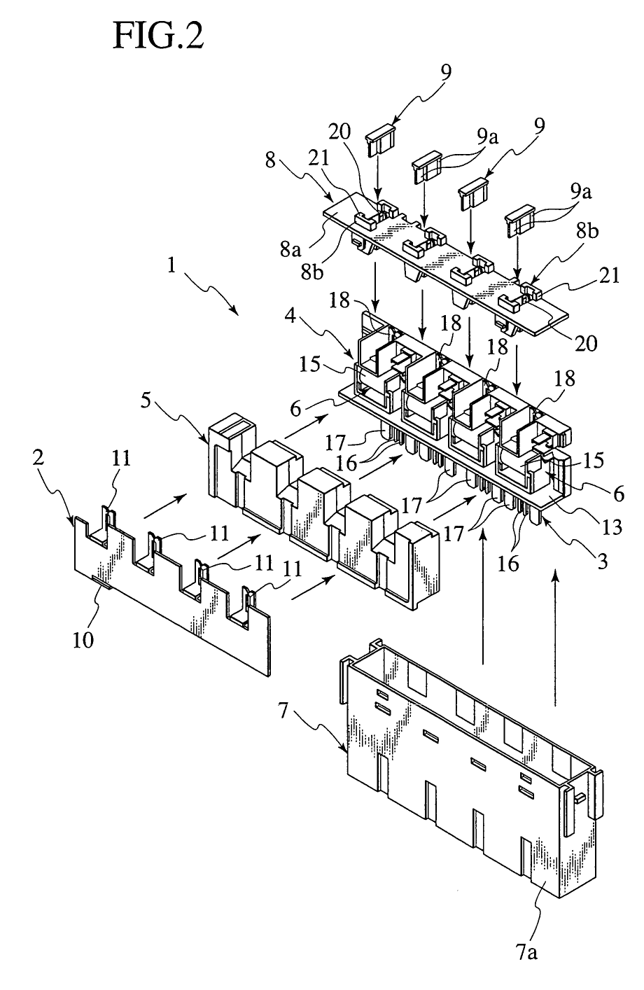

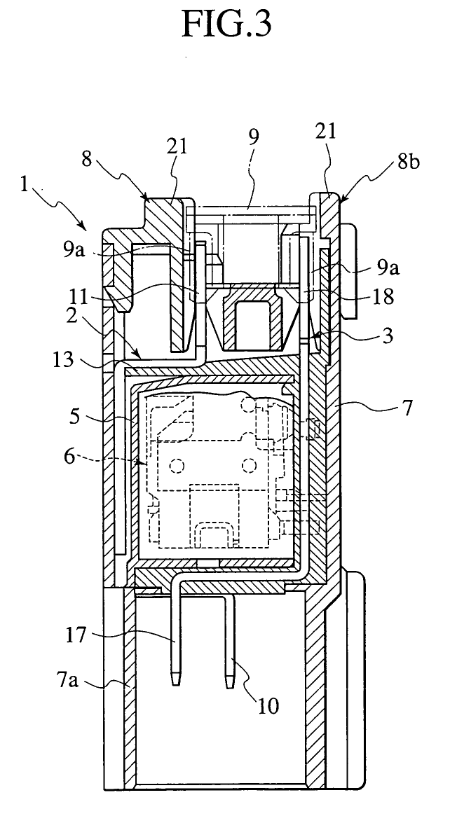

As shown in FIG. 2 and FIG. 3, the fuse box 1 comprises a first bus bar 2, a bus bar assembly 4 having a second bus bar 3, an inner cover 5 engaging with the bus bar assembly 4 and covering relay members 6, a case 7, and a fuse cavity 8 attached on the top of the case 7. The case 7 houses an assembly of the first bus bar 2, the bus bar assembly 4 and the inner cover 5. A fuse 9 is inserted into the insertion section 8b established on the fuse cavity 8.

The first bus bar 2 is formed by press forming a rigid metal material. The first bus bar 2 has a power terminal 10 at the lower end thereof and four fuse terminals 11.

The bus bar assembly 4 includes a bus bar (not shown) formed by pressing and molded by an insert mold process to establish a resinous base 13, a plurality of coils 15 and switches (not shown). The relay members 6 comprise the coils 15 and the switches attached on the second bus bar 3. The bus bar assembly 4 further includes a plurality of control terminals 16 and output terminals 17 at the lower end thereof, a plurality of fuse terminals 18 at the upper end thereof, and the plurality of the coils 15 and the switches at the intermediate portion thereof.

The inner cover 5 is formed of resin and configured to engage with the bus bar assembly 4 to house each of the relay members 6, respectively. The inner cover 5 is sandwiched between the bus bar assembly 4 and the first bus bar 2. The first bus bar 2 attached to the bus bar assembly 4 faces to the second bus bar 3.

The case 7 has an upper opening and a lower opening. A connector cavity 7a is formed at the lower part of the case 7. The assembly of the first bus bar 2, the inner cover 5 and bus bar assembly 4 is telescoped into the case 7 from the upper opening. The power terminal 10, the control terminal 16 and output terminal 17 are housed in the connector cavity 7a.

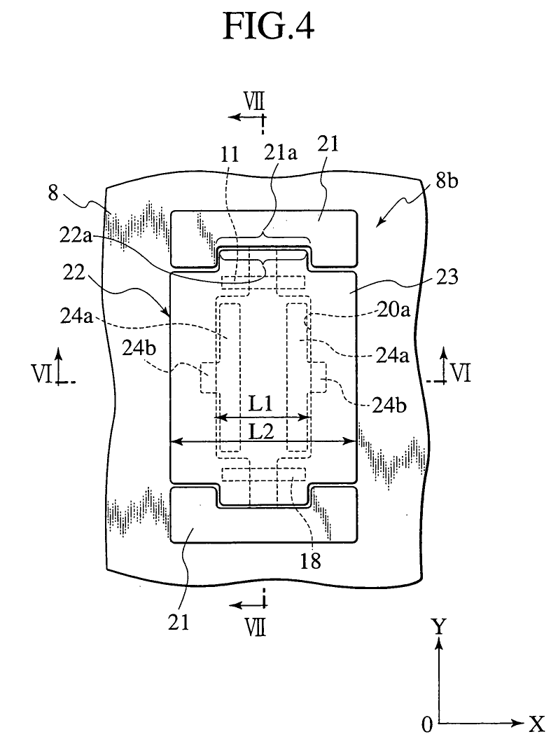

The fuse cavity 8 is attached on the top of the case 7 and has a panel portion 8a configured to cover the top of the case 7 and the insertion section 8b established on the panel portion 8a. The insertion sections 8b includes a rectangular fuse hole 20 penetrating the panel portion 8b and a pair of a guide portions 21 extending vertically from the panel portion 8b. As shown in FIG. 4, the guide portions 21 are parallel to each other and a first axis X. A concave portion 21a is formed in the guide portion 21 configured to fit with a salient portion 22a in the fuse hole plug 22. The fuse hole plug 22 has the salient portion 22a configured to fit with the concave portion 21a. The guide portion 21 and the fuse hole plug 22 may be of any shape as long as the fuse hole plug 22 is guided in the guide portion 21.

The pair of fuse terminals 11, 18 are parallel to each other and the first axis X inside the fuse hole 20. Each of the fuse terminals 11, 18 has a slit at the top configured to clip the fuse terminals 11, 18. A pair of terminal tabs 9a (shown in FIG. 2) in the fuse 9 is pressed in the slits respectively to connect with the fuse terminals 11, 18 electrically.

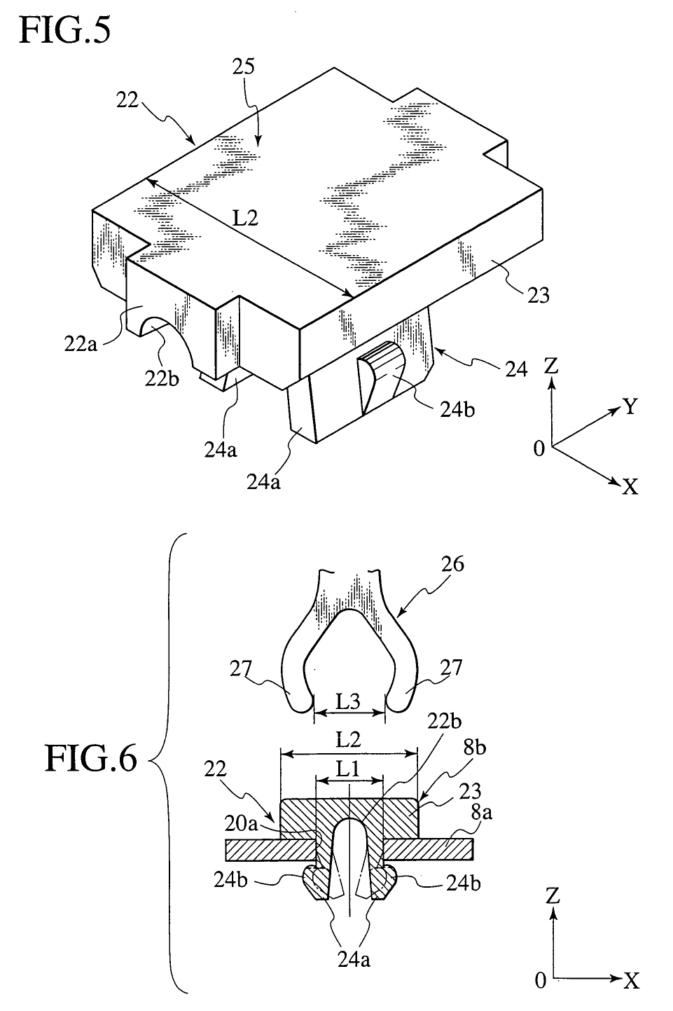

The fuse hole plug 22 is inserted into the fuse hole 20 which is not designated to receive the fuse 9. As shown in FIG. 5, the fuse hole plug 22 includes a pair of hooks 24 and a head member 25. Each of the hooks 24 has an arm member 24a and a projection 24b. The head member 25 has a grip portion 23, the salient portion 22a and a groove 22b. A surface of the grip portion 23 is parallel to a second axis Y horizontally perpendicular to the first axis X. The groove 22b is established along a centerline on the bottom of the head member 25. The centerline is parallel to a surface of the grip portion 23. The arm members 24a extend from the bottom of the head member 25 and are parallel to each other and to the surface of the grip portion 23. The projection 24b is established on an outer surface of each of the arm members 24a.

As shown in FIG. 6, a width L2 of the top surface of the head member 25 is larger than a width L1 of the fuse hole 20 and a width L3 in the direction of the first axis X between arms 27 of a fuse puller 26 which pulls out the fuse 9 by pinching with the arms. The grip portion 23 is pressed to incline the arm members 24a inward by bending the head member 25 as shown in FIG. 6. The groove 22b is established to bend the head member 25 readily by applying leverage thereto. The hooks 24 are inserted into the fuse hole 20 while inclining inward. The hooks 24 secure the fuse hole plug 22 in the fuse hole 20. The outer surface of the arm member 24a contacts a periphery 20a of the fuse hole 20 inside. The projection 24b hooks on a lower edge of the periphery 20a to connect the fuse hole plug 22 and the panel portion 8a. The bottom of the head member 25 contacts a top surface of the panel portion 8a.

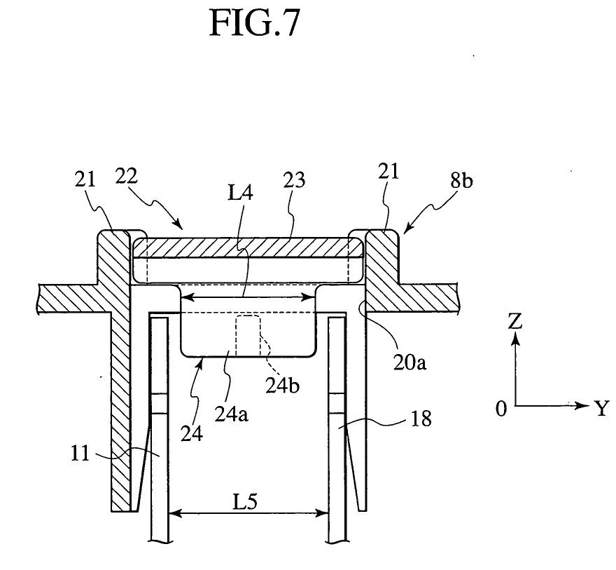

As shown in FIG. 7, a width L4 of the arm member 24a in the direction of the second axis Y is smaller than a length L5 between the fuse terminal 11 and the fuse terminal 18. Also, the width L4 is substantially the same as the length of the fuse hole 20 in the direction of the second axis Y, as shown in FIG. 4.

The fuse hole plug 22 can not be pinched with the fuse puller 26 because the width L2 is wider than the width L3. Consequently, the fuse hole plug 22 is not accidentally pulled out. Also, foreign matter, water, conductive dirt and the like are prevented from entering the fuse hole 20, adhering on the fuse terminals 11, 18 and causing mechanical errors because of sealing the fuse hole 20 with the fuse hole plug 22. The fuse hole plug 22 prevents damage of the slit of the fuse terminals 11, 18 because the fuse hole plug 22 does not expand the width of the slit. Various modifications will become possible for those skilled in the art after receiving the teachings of the present disclosure without departing from the scope thereof.

What is claimed is:

1. A fuse hole plug configured to be inserted in a fuse hole which is not designated to receive a fuse with a fuse puller, the fuse hole plug comprising a head member having a width wider than a width of the fuse hole.

2. The fuse hole plug of claim 1, further comprising a plurality of hooks configured to secure the fuse hole plug in the fuse hole.

3. The fuse hole plug of claim 2, wherein each of the hooks has
an arm member extending from a bottom of the head member configured to contact a periphery of the fuse hole; and
a projection established on an outer surface of each of the arm member configured to hook on a lower edge of the peripheral.

4. The fuse hole plug of claim 3, comprising:
a grip portion configured to be pressed to incline the arm members inward by bending the head member;
a groove established along a centerline parallel to a surface of the grip portion on a bottom of the head member.

5. The fuse hole plug of claim 1, comprising a salient portion configured to fit with a concave portion formed in a guide portion to guide the fuse hole plug.

6. The fuse hole plug of claim 1, further comprising a head member having a width wider than a width between arms of the fuse puller.

7. A fuse box device comprising:
a fuse box having a plurality of fuse holes configured to receive one of a fuse;
a fuse hole plug having a head member to be inserted in at least one of the plurality of fuse holes when a fuse is unnecessary; and
a fuse puller configured to remove a fuse from at least one of the plurality of fuse holes,
wherein the head member has a width wider than a width between arms of the fuse puller.

8. The fuse box device of claim 7, wherein the fuse hole plug has a plurality of hooks configured to secure the fuse hole plug in the fuse hole.

9. The fuse box device of claim 8, wherein each of the hooks has
an arm member extending from a bottom of the head member configured to contact a periphery of the fuse hole; and
a projection established on an outer surface of each of the arm member configured to hook on a lower edge of the peripheral.

10. The fuse box device of claim 9, wherein the fuse hole plug has
a grip portion configured to be pressed to incline the arm members inward by bending the head member; and
a groove established along a centerline parallel to a surface of the grip portion on a bottom of the head member.

11. The fuse box device of claim 7, wherein the fuse hole plug has a salient portion configured to fit with a concave portion formed in a guide portion to guide the fuse hole plug.
